(19) United States
(12) Patent Application Publication
(10) Pub. No.: US 2008/0137101 A1
(43) Pub. Date: Jun. 12, 2008

(54) Apparatus and Method for Obtaining Surface Texture Information

(75) Inventors: Andrew Desmond Spence, Lothian (GB); Michael J. Chantler, Lothian (GB)

Correspondence Address: GOODWIN PROCTER LLP;PATENT ADMINISTRATOR, EXCHANGE PLACE, BOSTON, MA, 02109-2881, US

(73) Assignee: Heriot-Watt University, Lothian (GB)

(21) Appl. No.: 11/666,190

(22) PCT Filed: Nov. 3, 2005
(86) PCT No.: PCT/GB05/04241

§ 371 Date: Jan. 15, 2008

(30) Foreign Application Priority Data
Nov. 3, 2004 (GB) 0424417.4

(51) Int. Cl. G01B 11/30; G06K 9/32

(52) U.S. Cl. 356/611; 382/294

(57) ABSTRACT

An apparatus and method for obtaining surface texture information using photometric stereo. The material for which surface height and reflectance function information is desired (“the material”) is illuminated with an illumination source emitting electromagnetic waves, preferably in the form of white light, which is consequently reflected by the material to be scanned into an imaging sensor. The position and orientation of the illumination source relative to the sensor is constant. The material is placed within or on top of a holding apparatus, such as a pane of glass, which is oriented in order to keep the illumination vector constant with respect to the imaged surface. The illumination source and sensor are moved in unison across the surface in order to progressively capture a complete image of the surface; this operation may be facilitated in practice through the use of hardware such as a flatbed scanner.

The present invention relates to an apparatus and method for obtaining surface texture information using photometric stereo. In particular, the present invention allows the estimation of height, surface derivative and reflectance functions of a surface using a light source and imaging device.

Photometric stereo, is an area of science involving algorithms that estimate surface properties, such as height, surface derivatives and albedo.

It requires n (where n>1) images of a surface illuminated from n different directions. The n images must be ‘registered’. Registered means that the n pixels occurring at the same (x,y) location in the n images must relate to the same physical area of the surface i.e. the images are spatially aligned.

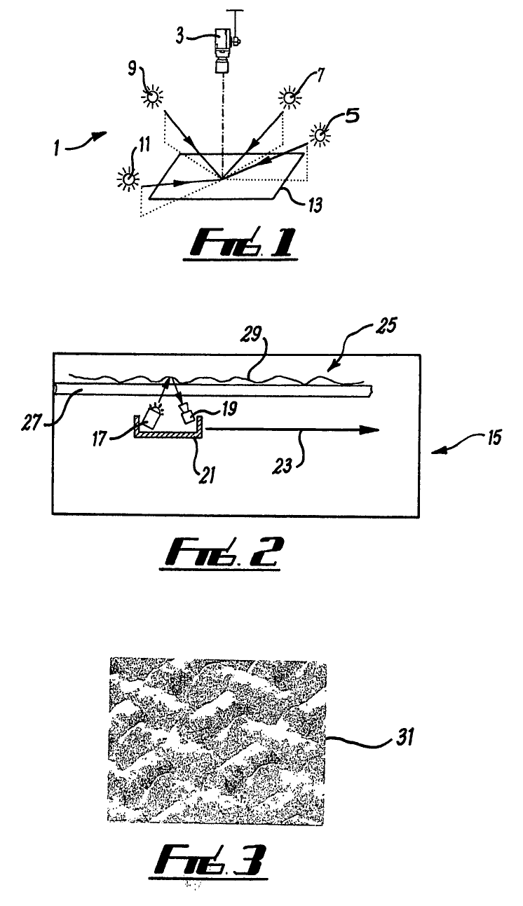

The easiest way to arrange this is to fix the camera and the surface in place and then to take a sequence of n images in which only the position of the illumination is changed. FIG. 1 is an example of the prior art and shows a camera 3 positioned above a surface plane 13 having lights 5, 7, 9 and 11 positioned at various angles with respect to the surface plane. The operation of each of these lights, successively, provides a sequence of n images to allow photometric stereo to be used to provide surface information.

Normally the illumination source is kept a reasonable distance away from the target surface to ensure that the direction of the illumination incident on the surface does not vary significantly over the surface. The implication is that the light direction can be assumed as constant over all of the illuminated surface.

Thus with existing systems the camera is positioned and fixed above the surface, the illumination source is fixed in its first position, the whole of image one is captured, the illumination source is moved to the 2^{nd} position, the whole of image two is captured, and so on. This is repeated until all n images have been captured.

Photometric stereo is performed upon the n registered images and recovers height, derivative and reflectance information of the surface of an object.

The process of conducting photometric stereo requires specialist knowledge, accurate manipulation of light sources and dark room facilities.

It is an object of the present invention to provide an apparatus and method for obtaining surface texture information that can be conveniently used by a person without specialist knowledge or sophisticated specialist equipment.

Essential, preferred and optional features of the method and apparatus of the invention are described in the attached claims. In addition, the following general discussion of the features of the invention is provided.

The material for which surface height and reflectance function information is desired (“the material”) is illuminated with an illumination source emitting electromagnetic waves, preferably in the form of white light, which is consequently reflected by the material to be scanned into an imaging sensor.

The position and orientation of the illumination source relative to the sensor is constant.

The material is preferably placed within or on top of a holding apparatus, such as a pane of glass, which is oriented in order to keep the illumination vector constant with respect to the imaged surface.

The illumination source and sensor are moved in unison across the surface in order to progressively capture a complete image of the surface; this operation may be facilitated in practice through the use of hardware such as a flatbed scanner.

Alternatively, an image may be acquired by using a camera (still or video) and a light. In this case both the camera and the light are fixed in position relative to each other and the material and the whole image is captured at once. The material and holding apparatus are placed along the line of sight of the camera such that they are parallel to the camera's sensor.

Following image acquisition, the orientation of the material relative to the illumination source and sensor is changed and the image acquisition-process is repeated. The image acquisition process is subsequently repeated as many times as necessary to acquire n unregistered images.

Following this, photometric stereo is performed upon the n unregistered images to estimate surface characteristics. These calculations involve the transformation of the unregistered images such that they become registered. Each registration operation requires the parameters for the corresponding transformation, which can be linear, non-linear or a combination thereof, to be determined.

The image registration step can either be performed before the photometric stereo calculations or simultaneously with the photometric stereo calculations.

The former approach necessitates the acquisition of a series of corresponding points between the images in order to accurately estimate the transformations; this operation is facilitated by, for example, acquiring images of the material attached to a mounting plate containing registration marks.

In the more general case when a series of corresponding points is not available, the transformation parameters have to be guessed and the latter simultaneous approach is utilised. It may even be used if the parameters have been estimated, since the resulting transformations provide a good initial guess.

### Simultaneous Photometric Stereo and Image Registration

This simultaneous image registration and height/reflectance data generating operation involves an optimisation procedure. A minimum of three images is required for its implementation (n>2).

One image is designated as a reference image. The other (n−1) images are defined as floating images. We assume that information from which the transformation can be calculated is not available. Instead an initial guess of the requisite transformation is provided for each floating image. The floating images or sections thereof (which may be of different resolution to the original) are transformed by the transformation estimate. Interpolation may be required to ensure that the corresponding intensity values are assigned to new grid co-ordinates which are discrete.

It is noted that a number of smaller sections and/or different resolutions may be employed to improve the efficiency and effectiveness of the optimisation and that this may be done in an iterative manner.

The illumination direction corresponding to each floating image is estimated based on the transformation (the angle of rotation). Photometric stereo is implemented by using the intensity data to generate an estimate of the surface geometry and reflectance data (or some equivalent representation). A relit image (or sections thereof) is generated by combining the surface geometry and reflectance data with illumination information corresponding to the reference image.

The difference between the estimate of the reference image (or sections thereof) and the actual image (or sections thereof) is calculated. Use of a single value defining the intensity difference such as the mean square error is advantageous.

If the difference measure is not sufficiently small, the parameters of the transformation matrice are updated according to an optimisation method such as the Nelder-Mead technique. The process is repeated until the difference has been minimised or is sufficiently small. The output is n registered images and data which represents the surface height and reflectance of the material.

### Use of Registration Marks (or Similar) for Photometric Stereo

This alternative approach involves an initial image registration step. Having spatially aligned the images they can be used as input data to the standard photometric stereo algorithm. This approach can be optionally combined with the method described above to provide an initial estimate of the transformations.

To register the images, one is designated as a reference image. The other (n−1) images are defined as floating images and are to be geometrically transformed so that they are spatially aligned with the reference image.

The reference image is processed to identify the position of either:

(a) external landmarks or features e.g. colour coded marks,

(b) intrinsic features of the image e.g. edges, distinctive hue, or

(c) intrinsic areas of the texture.

A floating image is processed to identify the position of the equivalent features or areas. An appropriate type of transformation (e.g. affine) between the two sets of features/area positions is selected and the corresponding matrix is calculated.

The floating image is transformed by the transformation to spatially align it with the reference image. Interpolation may be required to ensure that the corresponding intensity values are assigned to new grid co-ordinates which are discrete.

The above procedure is repeated for each of the remaining (n−2) floating images.

The n unregistered images are thereby converted to n registered images.

A photometric stereo algorithm can now be applied.

The present invention will now be described by way of example only with reference to the accompanying drawings in which:

FIG. 1 shows an example of a prior art photometric stereo system;

FIG. 2 shows an example of an apparatus in accordance with the present invention;

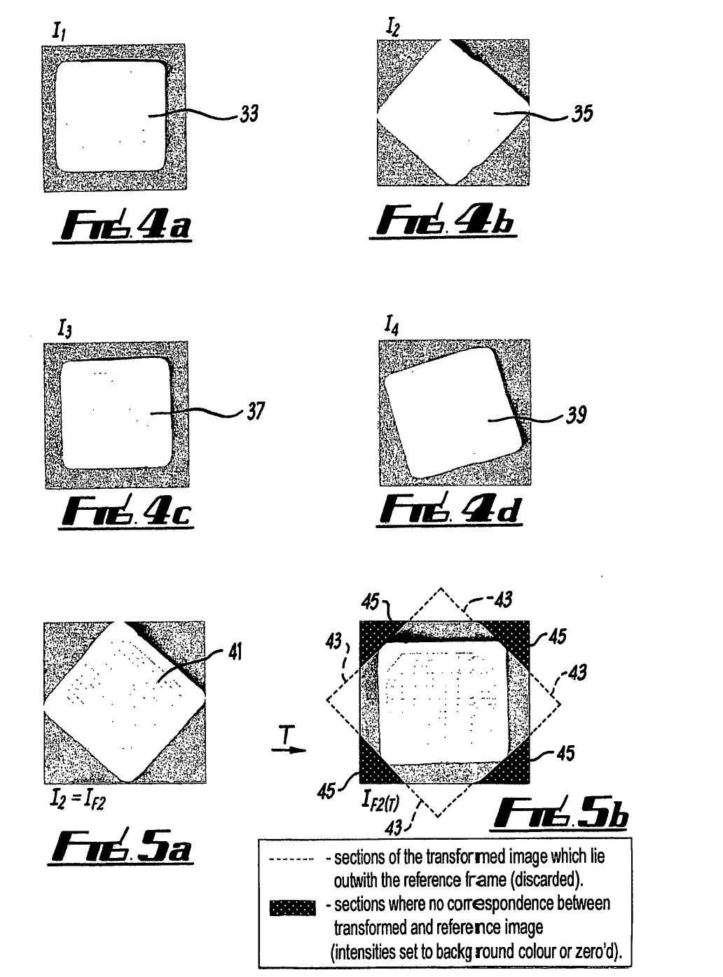

FIG. 3 shows an example of a height map of embossed wallpaper produced in accordance with the apparatus and method of the present invention;

FIGS. 4a to 4d are photographs of a texture attached to a backing plate for four different unknown orientations;

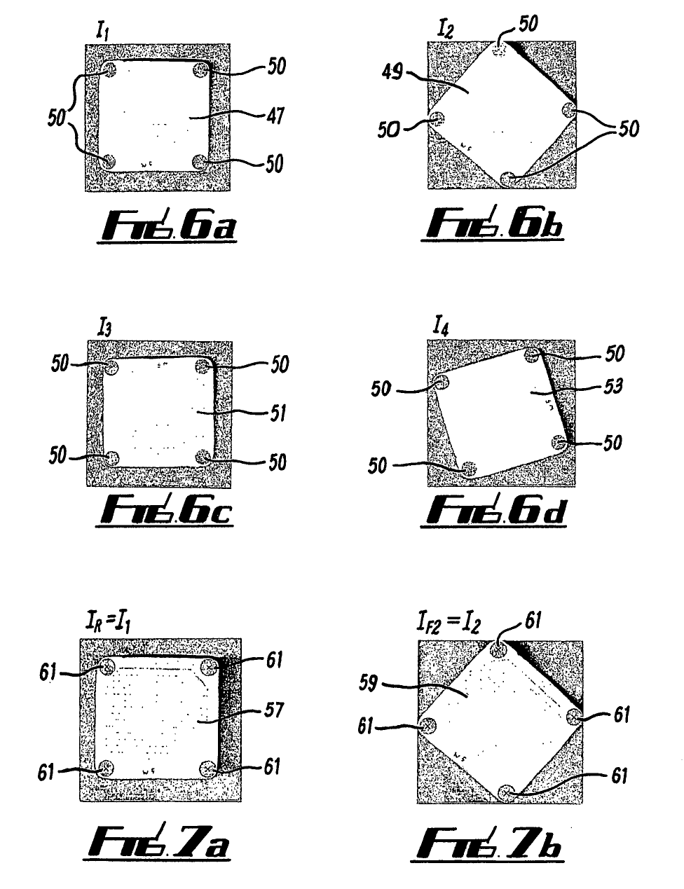

FIGS. 5a and 5b show a floating image and its transformation;

FIGS. 6a to 6d are photographs of a texture attached to a backing plate with registration marks for four different unknown orientations;

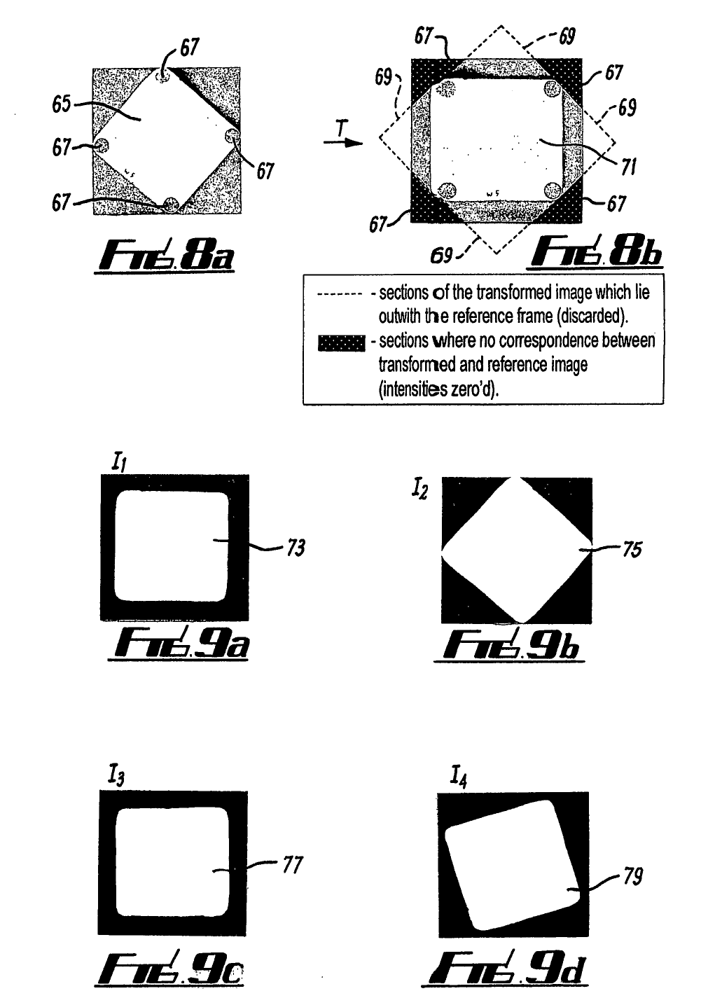

FIGS. 7a and 7b show the identification of the centre point of a registration mark;

FIGS. 8a and 8b show a floating image and its transformation;

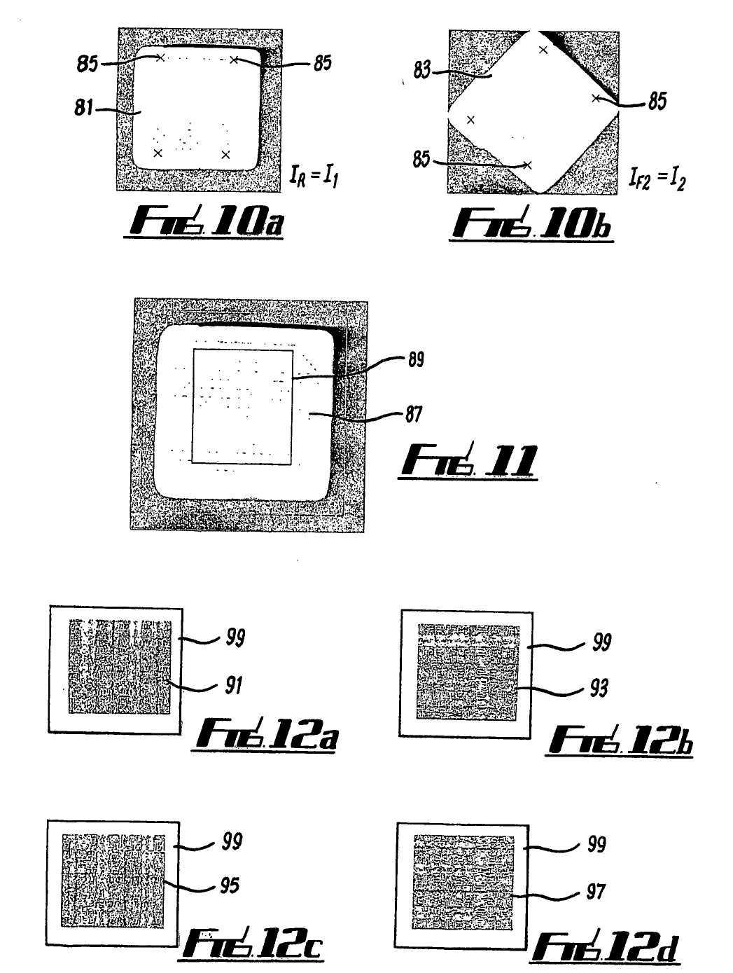

FIGS. 9a to 9d show a texture in silhouette;

FIGS. 10a and 10b show the identification of feature points on an image;

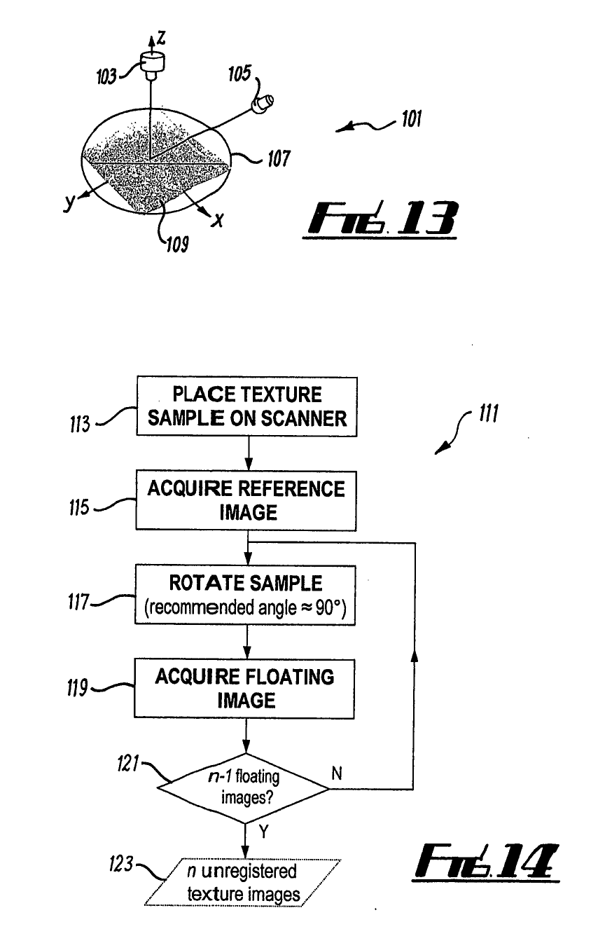

FIG. 11 shows the selection of small sections of an image to facilitate faster optimisation;

FIGS. 12a to 12d show photographs of a texture within a frame;

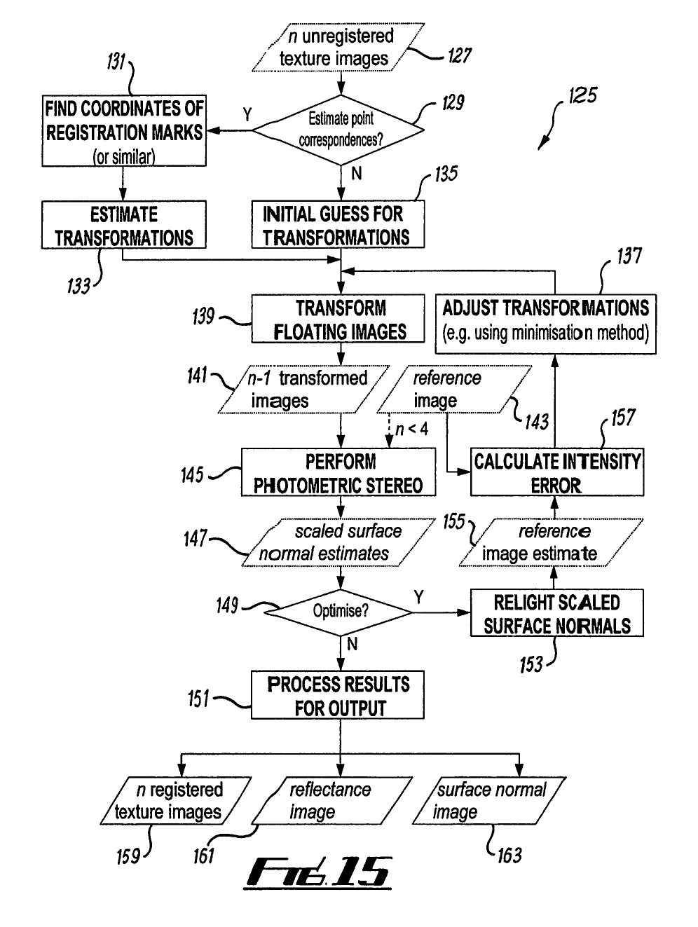

FIG. 13 shows a second embodiment of an apparatus in accordance with the present invention;

FIG. 14 is a flowchart describing a method of image acquisition in accordance with the present invention;

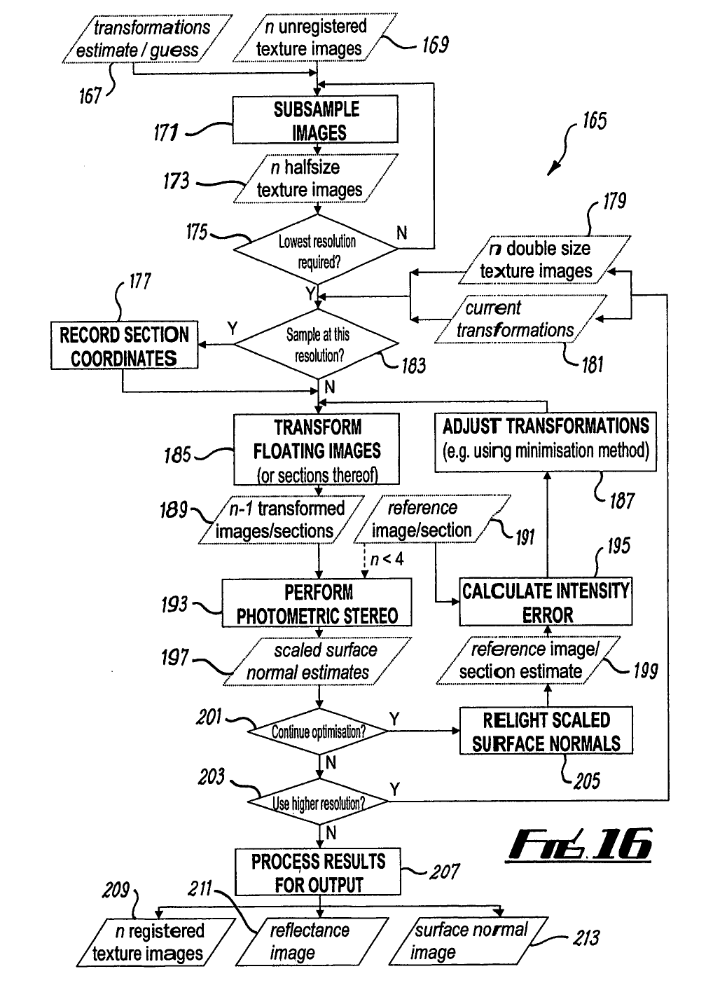

FIG. 15 is a flowchart for implementing an embodiment of the method of the present invention;

FIG. 16 is a flowchart which describes methods of improving optimisation in accordance with the present invention.

Ten embodiments of the present invention are provided below.

1. Use of photometric stereo for image registration

2. Use of photometric stereo for image registration (using image sections).

3. Implementation of photometric stereo with unregistered images:—
(a) using registration marks
(b) using registration marks and optimisation.
(c) using background contrast for registration.
(d) using background contrast and optimisation for registration.
(e) employing user input for registration.
(f) employing user input and optimisation for registration
(g) using mechanical device input for registration.
(h) using mechanical device input and optimisation for registration

1. Use of Photometric Stereo for Image Registration

In this embodiment of the current invention the illumination source and sensor may be contained within a flatbed scanner. FIG. 2 shows a flat bed scanner 15 for use with the present invention. The apparatus comprises a light source 17 and an image sensor 19 contained within a support 21 that fixes the position of and direction in which the light source 17 and image sensor 19 are facing with respect to surface. Arrow 23 shows the scan direction in which the support 21 moves thereby moving any light source 17 and the image sensor 19 across the surface. The samples base 25 is defined by a glass plate 27 which supports the sample to be scanned 29. In addition, processing means are provided to allow image information to be processed in accordance with the following procedure.

Acquire input data by scanning a texture sample e.g. embossed wallpaper, which may be attached to a backing plate, under n>3 different orientations.

Result is n intensity images which may be colour or greyscale Iᵢ where i=1 to n. In the following we will assume that n=4 (see FIG. 4).

If the texture sample is larger than the scanner area and may not be cut to size, a frame of one colour may be attached to the surface (see FIG. 12).

Designate one image to be the reference image e.g. I_{R}=I₁ and the others as floating images e.g. I_{Fi}=Iᵢ₊₁ where i=1 to 3, which are to be geometrically aligned with the reference image. Sample the intensities of the background region (i.e. not material or backing plate) in the reference image and assign the average intensity as the background colour.

Provide initial estimate of the transforms required to geometrically align the floating images with the reference image: Tᵢ where i=1 to 3.

For example, the simplest case whereby each transform Tᵢ involves a translation and a rotation is given by:

$${T}_{i} = [ \begin{matrix}cos {θ}_{i} & - sin {θ}_{i} & Δ {x}_{i} \\ sin {θ}_{i} & cos {θ}_{i} & Δ {y}_{i} \\ 0 & 0 & 1\end{matrix} ]$$

where θᵢ is the angle of rotation, Δxᵢ is the translation along the x-axis, Δyᵢ is the translation along the y-axis.

Since three transforms are needed (for n=4), nine parameters must be specified in this case. The parameter set is therefore:

Θ=[(θ₁, Δx₁, Δy₁), (θ₂, Δx₂, Δy₂), (θ₃, Δx₃, Δy₃)]

It is noted that more complex transforms may be required for greater accuracy e.g. affine or projective, in which case the matrix Tᵢ will be defined as a general three by three matrix. In this case there are up to nine parameters to determine for each transformation (rather than three for rotation and translation).

$${T}_{i} = [ \begin{matrix}{t}_{11} & {t}_{12} & {t}_{13} \\ {t}_{21} & {t}_{22} & {t}_{23} \\ {t}_{31} & {t}_{32} & {t}_{33}\end{matrix} ]$$

Refine the transformations by performing an optimisation as follows:

Begin loop.

Transform the floating images. This involves multiplication of each image grid co-ordinate by the corresponding transform Tᵢ:

$$[ \begin{matrix}{x}^{′} \\ {y}^{′} \\ 1\end{matrix} ] = {T}_{i} [ \begin{matrix}x \\ y \\ 1\end{matrix} ]$$

where [x y 1]^{T} is the floating image grid co-ordinate, [x′ y′ 1]^{T} is the transformed image grid co-ordinate, x=0 to (image width-1), y=0 to (image height-1). This operation is likely to produce non-discrete values and in practice will necessitate the use of interpolation to produce discrete co-ordinates. This actually entails an inverse transformation of the known co-ordinates for the grid of the transformed image into non-discrete values corresponding to the floating image grid. Assign the background colour to each co-ordinate in the transformed image for which there is no correspondence; see sections identified by numeral 45 in FIG. 5. The intensity for each remaining co-ordinate in the transformed image is calculated from the known intensities of the grid co-ordinates surrounding the non-discrete coordinate in the floating image. Floating image intensities which are not employed are effectively discarded; see sections identified by numeral 43 in FIG. 5. The transformed floating images I_{Fi(T)} where i=1 to 3, are thus generated.

A number of images are used to implement photometric stereo; these are chosen from the reference or transformed floating images. In this embodiment we opt for the three-image photometric stereo algorithm and use transformed images I_{Fi(T)} where i=1, 2, 3 as input data.

An intensity matrix I is formed. Each column of I corresponds to one of the images I_{Fi(T)}. This operation entails the conversion of each image matrix (2D) to a vector (1D). The matrix I is therefore b by three in size where b=(image width*image height).

$$I = [ \begin{matrix}[ \begin{matrix}⋮ \\ {I}_{{F}_{1} ( T )} \\ ⋮\end{matrix} ] & [ \begin{matrix}⋮ \\ {I}_{{F}_{2} ( T )} \\ ⋮\end{matrix} ] & [ \begin{matrix}⋮ \\ {I}_{{F}_{3} ( T )} \\ ⋮\end{matrix} ]\end{matrix} ]$$

An illumination matrix L is formed. This requires the illumination vector corresponding to each image to be defined. The illumination tilt angles τᵢ are deduced from the angles of rotation for the three transformations θᵢ. The illumination slant angle σ is assumed to be constant. It could be measured by implementing a scanner calibration step but in this embodiment we assign a value of 45°. The only consequence is that this introduces a scaling factor into the output data of the photometric stereo algorithm.

$$L = [ \begin{matrix}cos {τ}_{1} sin {45}^{∘} & cos {τ}_{2} sin {45}^{∘} & cos {τ}_{3} sin {45}^{∘} \\ sin {τ}_{1} sin {45}^{∘} & sin {τ}_{2} sin {45}^{∘} & sin {τ}_{3} sin {45}^{∘} \\ cos {45}^{∘} & cos {45}^{∘} & cos {45}^{∘}\end{matrix} ]$$

Assuming Lambertian reflectance, the following can be written: I=SL where S is the scaled surface normal matrix. S is determined by inverting the illumination matrix such that S=IL⁻¹.

Phong reflectance could also be used but would necessitate an increase in the number of parameters to be optimised. In this case the parameter set Θ would be increased to include a term R. For diffuse reflection R would be null. For specular reflection R would consist of two parameters: the Phong exponent and the proportion of specular to diffuse reflection.

Θ=[(θ₁, Δx₁, Δy₁), (θ₂, Δx₂, Δy₂), (θ₃, Δx₃, Δy₃),R]

An estimate of the reference image is now generated using the scaled surface normals. In this case we assume that the illumination tilt angle z=0°. The slant angle σ is taken as 45° due to the previous assumption:

$${I}_{R ( EST )} = {SI}_{R}$$

$${I}_{R} = {( cos {0}^{∘} sin {45}^{∘} sin {0}^{∘} sin {45}^{∘} cos {45}^{°} )}^{T} \\ = {( 0.707 \begin{matrix}0.0 & 0.707\end{matrix} )}^{T}$$

The difference between the estimated reference image and the actual reference image is determined in terms of a suitable measure such as the mean square error e:

$$e = \frac{\frac{1}{b} \sqrt{{\sum }_{k = 1}^{b} {( {i}_{R ( EST )} ( k ) - {i}_{R} ( k ) )}^{2}}}{var ( {I}_{R} )}$$

where i is the intensity value of an element of the corresponding intensity image I.

If e is less than or equal to the minimum acceptable error then stop iteration. Else change parameter values in the set Θ, update the transformations and start another iteration.

In this case the output is four registered images and the scaled surface normal matrix S from which surface gradient maps and an albedo image can be derived. The gradient maps may be integrated into a height map. An example height map of the embossed wallpaper is provided in FIG. 3.

2. Use of Photometric Stereo for Image Registration (Using Image Sections)

This embodiment is equivalent to the first embodiment except that a number of small sections of the images as opposed to the whole image are used during the optimisation procedure.

In this embodiment of the current invention the illumination source and sensor may be contained within a flatbed scanner (see FIG. 2).

The procedure is as follows:

Acquire input data by scanning a texture sample e.g. embossed wallpaper, which may be attached to a backing plate, under n>3 different orientations.

Result is n intensity images which may be colour or greyscale Iᵢ where i=1 to n. In the following we will assume that n=4 (see FIG. 4).

If the texture sample is larger than the scanner area and may not be cut to size, a frame of one colour may be attached to the surface (see FIG. 12).

Designate one image to be the reference image e.g. I_{R}=I₁ and the others as floating images e.g. I_{Fi}=Iᵢ₊₁ where i=1 to 3, which are to be geometrically aligned with the reference image. Sample the intensities of the background region (i.e. not material or backing plate) in the reference image and assign the average intensity as the background colour.

Choose image sections as follows:

Select an m pixel-wide (where m>0) rectangular frame section from the area of the reference image corresponding to the material and record the corresponding image co-ordinates.

Although m should be as small as possible (ideally m=1), the length and breadth of the rectangular frame should be as large as possible without impinging on the background region in the reference image. The intensity gradient of the selected pixels should be as large as possible; it may be necessary to increase m to boost this.

Select an w pixel-wide (where w>0) rectangular frame section from the area of the reference image corresponding to the background and record the corresponding image co-ordinates.

Ideally using w=1, the length and breadth of the rectangular frame should be such as to enclose the material region without impinging on it. Nor should the frame be flush to the material region to avoid the effects of shadowing which may be prevalent in the area.

Provide initial estimate of the transforms required to geometrically align the floating images with the reference image: Tᵢ where i=1 to 3.

For example, the simplest case whereby each transform Tᵢ involves a translation and a rotation is given by:

$${T}_{i} = [ \begin{matrix}cos {θ}_{i} & - sin {θ}_{i} & Δ {x}_{i} \\ sin {θ}_{i} & cos {θ}_{i} & Δ {y}_{i} \\ 0 & 0 & 1\end{matrix} ]$$

where θ₁ is the angle of rotation, Δxᵢ is the translation along the x-axis, Δyᵢ is the translation along the y-axis.

Since three transforms are needed (for n=4), nine parameters must be specified in this case. The parameter set is therefore:

Θ=[(θ₁, Δy₁), (θ₂, Δx₂, Δy₂), (θ₃, Δx₃, y₃)]

It is noted that more complex transforms may be required for greater accuracy e.g. affine or projective, in which case the matrix Tᵢ will be defined as a general three by three matrix. In this case there are up to nine parameters to determine for each transformation (rather than three for rotation and translation).

$${T}_{i} = [ \begin{matrix}{t}_{11} & {t}_{12} & {t}_{13} \\ {t}_{21} & {t}_{22} & {t}_{23} \\ {t}_{31} & {t}_{32} & {t}_{33}\end{matrix} ]$$

Refine the transformations by performing an optimisation as follows:

Begin loop.

Transform the sections of the floating images. This involves multiplication of each image grid co-ordinate by the corresponding transform Tᵢ:

$$[ \begin{matrix}{x}^{′} \\ {y}^{′} \\ 1\end{matrix} ] = {T}_{i} [ \begin{matrix}x \\ y \\ 1\end{matrix} ]$$

where [x y 1]^{T} is the floating image grid co-ordinate, [x′ y′ 1]^{T} is the transformed image grid co-ordinate, x=0 to (image width-1), y=0 to (image height-1). This operation is likely to produce non-discrete values and in practice will necessitate the use of interpolation to produce discrete co-ordinates. This actually entails an inverse transformation of the known co-ordinates for the transformed image section into non-discrete values corresponding to the floating image grid. Assign the background colour to each co-ordinate in the transformed image section for which there is no correspondence. The intensity for each remaining co-ordinate in the transformed image section is calculated from the known intensities of the grid co-ordinates surrounding the non-discrete coordinate in the floating image using a standard technique. Sections of the transformed floating images I_{Fi(T)} where i=1 to 3, are thus generated.

In this embodiment a three-image photometric stereo algorithm is used. In this case only intensities corresponding to the selected reference image sections are used as input data rather than the complete image.

An intensity matrix Î is formed. Each column of Î contains the intensity values of the images I_{Fi(T)} corresponding to the limited set of co-ordinates. The matrix Î is therefore c by three in size where c=number of selected co-ordinates. It is noted that c<<b where b=(image width*image height).

$${I}^{⋀} = [ \begin{matrix}[ \begin{matrix}⋮ \\ {I}_{{F}_{1} ( T )}^{⋀} \\ ⋮\end{matrix} ] & [ \begin{matrix}⋮ \\ {I}_{{F}_{2} ( T )}^{⋀} \\ ⋮\end{matrix} ] & [ \begin{matrix}⋮ \\ {I}_{{F}_{3} ( T )}^{⋀} \\ ⋮\end{matrix} ]\end{matrix} ]$$

An illumination matrix L is formed. This requires the illumination vector corresponding to each image to be defined. The illumination tilt angles τᵢ are deduced from the angles of rotation for the three transformations θᵢ. The illumination slant angle σ is assumed to be constant. It could be measured by implementing a scanner calibration step but in this embodiment we assign a value of 45°. The only consequence is that this introduces a scaling factor into the output data of the photometric stereo algorithm.

$$L = [ \begin{matrix}cos {τ}_{1} sin {45}^{∘} & cos {τ}_{2} sin {45}^{∘} & cos {τ}_{3} sin {45}^{∘} \\ sin {τ}_{1} sin {45}^{∘} & sin {τ}_{2} sin {45}^{∘} & sin {τ}_{3} sin {45}^{∘} \\ cos {45}^{∘} & cos {45}^{∘} & cos {45}^{∘}\end{matrix} ]$$

Assuming Lambertian reflectance, the following can be written: Î=ŜL where Ŝ is the scaled surface normal matrix (whose elements describe the surface facet corresponding to each pixel co-ordinate). Ŝ is determined by inverting the illumination matrix such that Ŝ=ÎL⁻¹.

Phong reflectance could also be used but would necessitate an increase in the number of parameters to be optimised. In this case the parameter set Θ would be increased to include a term R. For diffuse reflection R would be null. For specular reflection R would consist of two parameters: the Phong exponent and the proportion of specular to diffuse reflection.

Θ=[(θ₁, Δx₁, Δy₁), (θ₂, Δx₂, Δy₂), (θ₃, Δx₃, Δy₃), R]

An estimate of the intensity values for the selected pixel co-ordinates of the reference image is now generated using the scaled surface normals. In this case we assume that the illumination tilt angle τ=0°. The slant angle σ is taken as 45° due to the previous assumption:

$${I}_{R ( EST )}^{⋀} = {S}^{⋀} {I}_{R}$$

$${I}_{R} = {( cos {0}^{∘} sin {45}^{∘} sin {0}^{∘} sin {45}^{∘} cos {45}^{∘} )}^{T} \\ = {( 0.707 \; 0.0 \; 0.707 )}^{T}$$

The difference between the estimated reference image pixel intensities and the actual reference image pixel intensities is determined in terms of a suitable measure such as the mean square error e:

$$e = \frac{\frac{1}{c} \sqrt{{\sum }_{k = 1}^{c} {( {i}_{R ( EST )}^{⋀} ( k ) - {i}_{R}^{⋀} ( k ) )}^{2}}}{var ( {I}_{R}^{⋀} )}$$

where î is the intensity value of an element of the corresponding intensity vector Î.

If e is less than or equal to the minimum acceptable error then stop iteration. Else change parameter values in the set Θ, update the transformations and start another iteration.

When e reaches an acceptable value, the images are registered. The images (whole as opposed to a number of sections) are then used as input to the photometric stereo algorithm to generate a complete scaled surface normal matrix S from which surface gradient maps and an albedo image can be derived. The gradient maps may be integrated into a height map. An example height map of the embossed wallpaper is provided in FIG. 3.

3. Implementation of Photometric Stereo with Unregistered Images (a) Using Registration Marks

Attach texture sample e.g. embossed wallpaper to a backing plate onto which has a number (≧2) of visible registration marks e.g. coloured circles. The exact number of marks required depends on the complexity of the transformation (rotation & translation, affine or projective).

In this embodiment of the current invention the illumination source and sensor may be contained within a flatbed scanner (see FIG. 2).

Acquire input data by scanning a texture sample attached to the backing plate, under three different orientations.
Result is three intensity images which may be colour or greyscale Iᵢ where i=1 to 3 (see FIG. 6a-c).

Designate one image as the reference image e.g. I_{R}=I₁ and the others as floating images e.g. I_{F1}=I₂ and I_{F2}=I₃, which are to be geometrically aligned with the reference image. Sample the intensities of the background region (i.e. not material or backing plate) in the reference image and assign the average intensity as the background colour.

Process the images to find the co-ordinates of the centre point of the registration marks. For example, the centre of the red circle in the reference image is [X_{R,red}, Y_{R,red}] (see FIG. 7).

Calculate the corresponding transform matrix Tᵢ where i=1 to 2 to register each floating image to the reference image.
For example, the simplest case whereby each transform Tᵢ involves a translation and a rotation is given by:

$$Δ {x}_{i} = {x}_{R , red} - {x}_{{F}_{i} , red}$$

$$Δ {y}_{i} = {y}_{R , red} - {y}_{{F}_{i} , red}$$

$${ϑ}_{i} = {cos}^{- 1} ( \begin{matrix}{[ {x}_{R , green} - {x}_{R , red} , {y}_{R , green} - {y}_{R , red} ]}^{T} \cdot \\ {[ {x}_{{F}_{i} , green} - {x}_{{F}_{i , red}} , {y}_{{F}_{i} , green} - {y}_{{F}_{i} red} ]}^{T}\end{matrix} )$$

$${T}_{i} = [ \begin{matrix}cos {θ}_{i} & - sin {θ}_{i} & Δ {x}_{i} \\ sin {θ}_{i} & cos {θ}_{i} & Δ {y}_{i} \\ 0 & 0 & 1\end{matrix} ]$$

It is noted that more complex transforms may be required for greater accuracy e.g. affine or projective, in which case the matrix Tᵢ will be defined as a general three by three matrix. In this case there are up to nine parameters to determine for each transformation (rather than three for rotation and translation).

$${T}_{i} = [ \begin{matrix}{t}_{11} & {t}_{12} & {t}_{13} \\ {t}_{21} & {t}_{22} & {t}_{23} \\ {t}_{31} & {t}_{32} & {t}_{33}\end{matrix} ]$$

Transform the floating images. This involves multiplication of each image grid co-ordinate by the corresponding transform Tᵢ where i=1 to 2:

$$[ \begin{matrix}{x}^{′} \\ {y}^{′} \\ 1\end{matrix} ] = {T}_{i} [ \begin{matrix}x \\ y \\ 1\end{matrix} ]$$

where [x y 1]^{T} is the floating image grid co-ordinate, [x′ y′ 1]^{T} is the transformed image grid co-ordinate, x=0 to (image width-1), y=0 to (image height-1). This operation is likely to produce non-discrete values and in practice will necessitate the use of interpolation to produce discrete co-ordinates. This actually entails an inverse transformation of the known co-ordinates for the grid of the transformed image into non-discrete values corresponding to the floating image grid. Assign the background colour to each co-ordinate in the transformed image for which there is no correspondence; see sections identified by numeral 67 in FIG. 8. The intensity for each remaining co-ordinate in the transformed image is calculated from the known intensities of the grid co-ordinates surrounding the non-discrete coordinate in the floating image. Floating image intensities which are not employed are effectively discarded; see sections identified by numeral 69 in FIG. 8. The transformed floating images I_{Fi(T)} where i=1 to 2, are thus generated.

Use the registered images I_{R}, I_{F1(T)} and I_{F2(T)} to implement the three-image photometric stereo technique.

An intensity matrix I is formed. Each column of I corresponds to one of the three registered images. This operation entails the conversion of each image matrix (2D) to a vector (1D). The matrix I is therefore b by three in size where b=(image width*image height).

$$I = [ \begin{matrix}[ \begin{matrix}⋮ \\ {I}_{R} \\ ⋮\end{matrix} ] & [ \begin{matrix}⋮ \\ {I}_{{F}_{1} ( T )} \\ ⋮\end{matrix} ] & [ \begin{matrix}⋮ \\ {I}_{{F}_{2} ( T )} \\ ⋮\end{matrix} ]\end{matrix} ]$$

An illumination matrix L is formed. The illumination tilt angles τᵢ corresponding to the transformed floating images are deduced from the angles of rotation for the transformations θᵢ. The illumination tilt angle for the reference image is 0°. The illumination slant angle σ is assumed to be constant. It could be measured by implementing a scanner calibration step but in this embodiment we assign a preferable value of 45°. The only consequence is that this introduces a scaling factor into the output data of the photometric stereo algorithm.

$$L = [ \begin{matrix}cos {0}^{∘} sin {45}^{∘} & cos {τ}_{1} sin {45}^{∘} & cos {τ}_{2} sin {45}^{∘} \\ sin {0}^{∘} sin {45}^{∘} & sin {τ}_{1} sin {45}^{∘} & sin {τ}_{2} sin {45}^{∘} \\ cos {45}^{∘} & cos {45}^{∘} & cos {45}^{∘}\end{matrix} ]$$

Assuming Lambertian reflectance, the following can be written: I=SL where S is the scaled surface normal matrix. S is determined by inverting the illumination matrix such that S=IL⁻¹.

In this case the output is three registered images and the scaled surface normal matrix S from which surface gradient maps and an albedo image can be derived. The gradient maps may be integrated into a height map. An example height map of the embossed wallpaper is provided in FIG. 3.

3. Implementation of Photometric Stereo with Unregistered Images (b) Using Registration Marks and Optimisation

The procedure for this embodiment is equivalent to the amalgamation of two previous embodiments (1 and 3a) and uses four input images.

Attach texture sample e.g. embossed wallpaper to a backing plate which has a number (≧2) of visible registration marks e.g. coloured circles.

In this embodiment of the current invention the illumination source and sensor may be contained within a flatbed scanner (see FIG. 2).

Acquire input data by scanning a texture sample attached to the backing plate, under four different orientations.

Result is four intensity images which may be colour or greyscale Iᵢ where i=1 to 4 (see FIG. 6a-d).

Process the images to find the co-ordinates of the centre point of the registration marks. For example, the centre of the red circle in the reference image is [x_{R,red}, y_{R,red}] (see FIG. 7).

Designate one image as the reference image e.g. I_{R}=I₁ and the others as floating images e.g. I_{Fi}=Iᵢ₊₁ where i=1 to 3, which are to be geometrically aligned with the reference image. Sample the intensities of the background region (i.e. not material or backing plate) in the reference image and assign the average intensity as the background colour.

Calculate the corresponding transform matrix Tᵢ where i=1 to 3 to register each floating image to the reference image. For example, the simplest case whereby each transform Tᵢ involves a translation and a rotation is given by:

$$Δ {x}_{i} = {x}_{R , red} - {x}_{{F}_{i , red}}$$

$$Δ {y}_{i} = {y}_{R , red} - {y}_{{F}_{i} , red}$$

$${ϑ}_{i} = {cos}^{- 1} ( \begin{matrix}{[ {x}_{R , green} - {x}_{R , red} , {y}_{R , green} - {y}_{R , red} ]}^{T} \cdot \\ {[ {x}_{{F}_{i} , green} - {x}_{{F}_{i} , red} , {y}_{{F}_{i} , green} - {y}_{{F}_{i , red}} ]}^{T}\end{matrix} )$$

$${T}_{i} = [ \begin{matrix}cos {θ}_{i} & - sin {θ}_{i} & Δ {x}_{i} \\ sin {θ}_{i} & cos {θ}_{i} & Δ {y}_{i} \\ 0 & 0 & 1\end{matrix} ]$$

It is noted that more complex transforms may be required for greater accuracy e.g. affine or projective, in which case the matrix Tᵢ will be defined as a general three by three matrix. In this case there are up to nine parameters to determine for each transformation (rather than three for rotation and translation).

$${T}_{i} = [ \begin{matrix}{t}_{11} & {t}_{12} & {t}_{13} \\ {t}_{21} & {t}_{22} & {t}_{23} \\ {t}_{31} & {t}_{32} & {t}_{33}\end{matrix} ]$$

Use the data generated to populate the parameter set Θ.

Θ=[(θ₁, Δx₁, Δy₂), (θ₂, Δx₂, Δy₂), (θ₃, Δx₃, Δy₃)]

Refine the transformations by performing an optimisation as follows:

Begin loop.

Transform the floating images. This involves multiplication of each image grid co-ordinate by the corresponding transform Tᵢ:

$$[ \begin{matrix}{x}^{′} \\ {y}^{′} \\ 1\end{matrix} ] = {T}_{i} [ \begin{matrix}x \\ y \\ 1\end{matrix} ]$$

where [x y 1]^{T} is the floating image grid co-ordinate, [x′ y′ 1]^{T} is the transformed image grid co-ordinate, x=0 to (image width-1), y=0 to (image height-1). This operation is likely to produce non-discrete values and in practice will necessitate the use of interpolation to produce discrete co-ordinates. This actually entails an inverse transformation of the known co-ordinates for the grid of the transformed image into non-discrete values corresponding to the floating image grid. Assign the background colour to each co-ordinate in the transformed image for which there is no correspondence. The intensity for each remaining co-ordinate in the transformed image is calculated from the known intensities of the grid co-ordinates surrounding the non-discrete coordinate in the floating image. The transformed floating images I_{Fi(T)} where i=1 to 3, are thus generated.

A number of images are then used to implement photometric stereo; these are chosen from the reference or transformed floating images. In this embodiment we opt for the three-image photometric stereo algorithm and use transformed images I_{Fi(T)} where i=1, 2, 3 as input data.

An intensity matrix I is formed. Each column of I corresponds to one of the images I_{Fi(T)}. This operation entails the conversion of each image matrix (2D) to a vector (1D). The matrix I is therefore b by three in size where b=(image width*image height).

$$I = [ \begin{matrix}[ \begin{matrix}⋮ \\ {I}_{{F}_{1} ( T )} \\ ⋮\end{matrix} ] & [ \begin{matrix}⋮ \\ {I}_{{F}_{2} ( T )} \\ ⋮\end{matrix} ] & [ \begin{matrix}⋮ \\ {I}_{{F}_{3} ( T )} \\ ⋮\end{matrix} ]\end{matrix} ]$$

An illumination matrix L is formed. This requires the illumination vector corresponding to each image to be defined. The illumination tilt angles τᵢ are deduced from the angles of rotation for the three transformations θᵢ. The illumination slant angle σ is assumed to be constant. It could be measured by implementing a scanner calibration step but in this embodiment we assign a value of 45°. The only consequence is that this introduces a scaling factor into the output data of the photometric stereo algorithm.

$$L = [ \begin{matrix}cos {τ}_{1} sin {45}^{∘} & cos {τ}_{2} sin {45}^{∘} & cos {τ}_{3} sin {45}^{∘} \\ sin {τ}_{1} sin {45}^{∘} & sin {τ}_{2} sin {45}^{∘} & sin {τ}^{3} sin {45}^{∘} \\ cos {45}^{∘} & cos {45}^{∘} & cos {45}^{∘}\end{matrix} ]$$

Assuming Lambertian reflectance, the following can be written: I=SL where S is the scaled surface normal matrix. S is determined by inverting the illumination matrix such that S=IL⁻¹.

Phong reflectance could also be used but would necessitate an increase in the number of parameters to be optimised. In this case the parameter set would be increased to include a term R. For diffuse reflection R would be null. For specular reflection R would consist of two parameters: the Phong exponent and the proportion of specular to diffuse reflection.

Θ=[(θ₁, Δx₁, Δy₂), (θ₂, Δx₂, Δy₂), (θ₃, Δx₃, Δy₃),R]

An estimate of the reference image is generated using the scaled surface normals. In this case we assume that the illumination tilt angle τ=0°. The slant angle is taken as 45° due to the previous assumption.

$${I}_{R ( EST )} = {SI}_{R}$$

$$\begin{matrix}{I}_{R} = {( cos {0}^{∘} sin {45}^{∘} sin {0}^{∘} sin {45}^{∘} cos {45}^{∘} )}^{T} \\ = {( 0.707 \; 0.0 \; 0.707 )}^{T}\end{matrix}$$

The difference between the estimated reference image and the actual reference image is determined in terms of a suitable measure such as the mean square error e:

$$e = \frac{\frac{1}{b} \sqrt{{\sum }_{k = 1}^{b} {( {i}_{R ( EST )} ( k ) - {i}_{R} ( k ) )}^{2}}}{var ( {I}_{R} )}$$

where i is the intensity value of an element of the corresponding intensity image I.

If e is less than or equal to the minimum acceptable error then stop iteration. Else change parameter values in the set Θ, update the transformations and start another iteration.

In this case the output is four registered images and the scaled surface normal matrix S from which surface gradient maps and an albedo image can be derived. The gradient maps may be integrated into a height map. An example height map of the embossed wallpaper is provided in FIG. 3.

3. Implementation of Photometric Stereo with Unregistered Images (c) Using Background Contrast for Registration

Procedure is analogous to the implementation of photometric stereo with unregistered images using registration marks except it uses background contrast instead of landmarks to effect the registration of the images.

In this embodiment of the current invention the illumination source and sensor may be contained within a flatbed scanner (see FIG. 2).

Acquire input data by scanning a texture sample e.g. embossed wallpaper, which may be attached to a backing plate, under three different orientations.

Result is three intensity images which may be colour or greyscale Iᵢ where i=1 to 3 (see FIG. 4a-c).

Designate one image as the reference image e.g. I_{R}=I₁ and the others as floating images e.g. I_{F1}=I₂ and I_{F2}=I₃, which are to be geometrically aligned with the reference image. Sample the intensities of the background region (i.e. not material or backing plate) in the reference image and assign the average intensity as the background colour.

Process the images to produce silhouettes (see FIG. 9). This can be achieved by thresholding the images as described by Owens.

Process the silhouettes to determine the requisite transforms Tᵢ where i=1 to 2. One approach to achieve this is to use binary image moments to determine the centre and the axis of orientation.

For example, the simplest case whereby each transform Tᵢ involves a translation and a rotation is given by:

$${T}_{i} = [ \begin{matrix}cos {θ}_{i} & - sin {θ}_{i} & Δ {x}_{i} \\ sin {θ}_{i} & cos {θ}_{i} & Δ {y}_{i} \\ 0 & 0 & 1\end{matrix} ]$$

where θᵢ is the angle of rotation, Δxᵢ is the translation along the x-axis, Δyᵢ is the translation along the y-axis.

Since three transforms are needed, nine parameters must be specified in this case. The parameter set is therefore:

Θ=[(θ₁, Δx₁, Δy₁), (θ₂, Δx₂, Δy₂), (θ₃, Δx₃, Δy₃)]

It is noted that more complex transforms may be required for greater accuracy e.g. affine or projective, in which case the matrix Tᵢ will be defined as a general three by three matrix. In this case there are up to nine parameters to determine for each transformation (rather than three for rotation and translation).

$${T}_{i} = [ \begin{matrix}{t}_{11} & {t}_{12} & {t}_{13} \\ {t}_{21} & {t}_{22} & {t}_{23} \\ {t}_{31} & {t}_{32} & {t}_{33}\end{matrix} ]$$

Transform the floating images. This involves multiplication of each image grid co-ordinate by the corresponding transform Tᵢ where i=1 to 2:

$$[ \begin{matrix}{x}^{′} \\ {y}^{′} \\ 1\end{matrix} ] = {T}_{i} [ \begin{matrix}x \\ y \\ 1\end{matrix} ]$$

where [x y 1]^{T} is the floating image grid co-ordinate, [x′ y′ 1]^{T} is the transformed image grid co-ordinate, x=0 to (image width-1), y=0 to (image height-1). This operation is likely to produce non-discrete values and in practice will necessitate the use of interpolation to produce discrete co-ordinates. This actually entails an inverse transformation of the known co-ordinates for the grid of the transformed image into non-discrete values corresponding to the floating image grid. Assign the background colour to each co-ordinate in the transformed image for which there is no correspondence. The intensity for each remaining co-ordinate in the transformed image is calculated from the known intensities of the grid co-ordinates surrounding the non-discrete coordinate in the floating image. The transformed floating images I_{Fi(T)} where i=1 to 2, are thus generated.

Use the registered images I_{R}, I_{F1(T)} and I_{F2(T)} to implement the three-image photometric stereo technique.

An intensity matrix I is formed. Each column of I corresponds to one of the three registered images. This operation entails the conversion of each image matrix (2D) to a vector (1D). The matrix I is therefore b by three in size where b=(image width*image height).

$$I = [ \begin{matrix}[ \begin{matrix}⋮ \\ {I}_{R} \\ ⋮\end{matrix} ] & [ \begin{matrix}⋮ \\ {I}_{{F}_{1} ( T )} \\ ⋮\end{matrix} ] & [ \begin{matrix}⋮ \\ {I}_{{F}_{2} ( T )} \\ ⋮\end{matrix} ]\end{matrix} ]$$

An illumination matrix L is formed. The illumination tilt angles r corresponding to the transformed floating images are deduced from the angles of rotation for the transformations θᵢ. The illumination tilt angle for the reference image is 0°. The illumination slant angle σ is assumed to be constant. It could be measured by implementing a scanner calibration step but in this embodiment we assign a value of 45°. The only consequence is that this introduces a scaling factor into the output data of the photometric stereo algorithm.

$$L = [ \begin{matrix}cos {0}^{∘} sin {45}^{∘} & cos {τ}_{1} sin {45}^{∘} & cos {τ}_{2} sin {45}^{∘} \\ sin {0}^{∘} sin {45}^{∘} & sin {τ}_{1} sin {45}^{∘} & sin {τ}_{2} sin {45}^{∘} \\ cos {45}^{∘} & cos {45}^{∘} & cos {45}^{∘}\end{matrix} ]$$

Assuming Lambertian reflectance, the following can be written: I=SL where S is the scaled surface normal matrix. S is determined by inverting the illumination matrix such that S=IL⁻¹.

In this case the output is three registered images and the scaled surface normal matrix S from which surface gradient maps and an albedo image can be derived. The gradient maps may be integrated into a height map. An example height map of the embossed wallpaper is provided in FIG. 3.

3. Implementation of Photometric Stereo with Unregistered Images (d) Using Background Contrast and Optimisation for Registration

The procedure for this embodiment is equivalent to the amalgamation of two previous embodiments (1 and 3c) and uses four input images.

In this embodiment of the current invention the illumination source and sensor may be contained within a flatbed scanner (see FIG. 2).

Acquire input data by scanning a texture sample e.g. embossed wallpaper, which may be attached to a backing plate, under four different orientations.

Result is four intensity images which may be colour or greyscale Iᵢ where i=1 to 4 (see FIG. 4a-d).

Designate one image to be the reference image e.g. I_{R}=I₁ and the others as floating images e.g. I_{Fi}=Iᵢ₊₁ where i=1 to n−1, which are to be geometrically aligned with the reference image.

Sample the intensities of the background region (i.e. not material or backing plate) in the reference image and assign the average intensity as the background colour.

Process the images to produce silhouettes (see FIG. 9). This can be achieved by thresholding the images as described by Owens.

Process the silhouettes to determine the requisite transforms Tᵢ where i=1 to 3. One approach to achieve this is to use binary image moments to determine the centre and the axis of orientation as described by Owens.

Provide initial estimate of the transforms required to geometrically align the floating images with the reference image: Tᵢ where i=1 to 3.

For example, the simplest case whereby each transform Tᵢ involves a translation and a rotation is given by:

$${T}_{i} = [ \begin{matrix}cos {θ}_{i} & - sin {θ}_{i} & Δ {x}_{i} \\ sin {θ}_{i} & cos {θ}_{i} & Δ {y}_{i} \\ 0 & 0 & 1\end{matrix} ]$$

where θᵢ is the angle of rotation, Δxᵢ is the translation along the x-axis, Δyᵢ is the translation along the y-axis.

Since three transforms are needed, nine parameters must be specified in this case. The parameter set is therefore:

Θ=[(θ₁, Δx₁, y₁), (θ₂, Δx₂, Δy₂), (θ₃, Δx₃, Δy₃)]

It is noted that more complex transforms may be required for greater accuracy e.g. affine or projective, in which case the matrix Tᵢ will be defined as a general three by three matrix. In this case there are up to nine parameters to determine for each transformation (rather than three for rotation and translation).

$${T}_{i} = [ \begin{matrix}{t}_{11} & {t}_{12} & {t}_{13} \\ {t}_{21} & {t}_{22} & {t}_{23} \\ {t}_{31} & {t}_{32} & {t}_{33}\end{matrix} ]$$

Refine the transformations by performing an optimisation as follows:

Begin loop.

Transform the floating images. This involves multiplication of each image grid co-ordinate by the corresponding transform Tᵢ:

$$[ \begin{matrix}{x}^{′} \\ {y}^{′} \\ 1\end{matrix} ] = {T}_{i} [ \begin{matrix}x \\ y \\ 1\end{matrix} ]$$

where [x y 1]^{T} is the floating image grid co-ordinate, [x′ y′ 1]T is the transformed image grid co-ordinate, x=0 to (image width-1), y=0 to (image height-1). This operation is likely to produce non-discrete values and in practice will necessitate the use of interpolation to produce discrete co-ordinates. This actually entails an inverse transformation of the known co-ordinates for the grid of the transformed image into non-discrete values corresponding to the floating image grid. Assign the background colour to each co-ordinate in the transformed image for which there is no correspondence. The intensity for each remaining co-ordinate in the transformed image is calculated from the known intensities of the grid coordinates surrounding the non-discrete coordinate in the floating image. The transformed floating images I_{Fi(T)} where i=1 to 3, are thus generated.

A number of images are then used to implement photometric stereo; these are chosen from the reference or transformed floating images. In this embodiment we opt for the three-image photometric stereo algorithm and use transformed images I_{Fi(T)} where i=1, 2, 3 as input data.

An intensity matrix I is formed. Each column of I corresponds to one of the images I_{Fi(T)}. This operation entails the conversion of each image matrix (2D) to a vector (1D). The matrix I is therefore b by three in size where b=(image width*image height).

$$I = [ \begin{matrix}[ \begin{matrix}⋮ \\ {I}_{{F}_{1} ( T )} \\ ⋮\end{matrix} ] & [ \begin{matrix}⋮ \\ {I}_{{F}_{2} ( T )} \\ ⋮\end{matrix} ] & [ \begin{matrix}⋮ \\ {I}_{{F}_{3} ( T )} \\ ⋮\end{matrix} ]\end{matrix} ]$$

An illumination matrix L is formed. This requires the illumination vector corresponding to each image to be defined. The illumination tilt angles τᵢ are deduced from the angles of rotation for the three transformations θᵢ. The illumination slant angle σ is assumed to be constant. It could be measured by implementing a scanner calibration step but in this embodiment we assign a value of 45°. The only consequence is that this introduces a scaling factor into the output data of the photometric stereo algorithm.

$$L = [ \begin{matrix}cos {τ}_{1} sin {45}^{∘} & cos {τ}_{2} sin {45}^{∘} & cos {τ}_{3} sin {45}^{∘} \\ sin {τ}_{1} sin {45}^{∘} & sin {τ}_{2} sin {45}^{∘} & sin {τ}_{3} sin {45}^{∘} \\ cos {45}^{∘} & cos {45}^{∘} & cos {45}^{∘}\end{matrix} ]$$

Assuming Lambertian reflectance, the following can be written: I=SL where S is the scaled surface normal matrix. S is determined by inverting the illumination matrix such that S=IL⁻¹.

Phong reflectance could also be used but would necessitate an increase in the number of parameters to be optimised. In this case the parameter set would be increased to include a term R. For diffuse reflection R would be null. For specular reflection R would consist of two parameters: the Phong exponent and the proportion of specular to diffuse reflection.

θ=[(θ₁, Δx₁, Δy₁), (θ₂, Δx₂, Δy₂), (θ₃, Δx₃, Δy₃), R]

An estimate of the reference image is generated using the scaled surface normals. In this case we assume that the illumination tilt angle τ=0°. The slant angle is taken as 45° due to the previous assumption.

$${I}_{R ( EST )} = {SI}_{k}$$

$$\begin{matrix}{I}_{R} = {( cos {0}^{∘} sin {45}^{∘} sin {0}^{∘} sin {45}^{∘} cos {45}^{∘} )}^{T} \\ = {( 0.707 \; 0.0 \; 0.707 )}^{T}\end{matrix}$$

The difference between the estimated reference image and the actual reference image is determined in terms of a suitable measure such as the mean square error e:

$$e = \frac{\frac{1}{b} \sqrt{{\sum }_{k = 1}^{b} {( {i}_{R ( EST )} ( k ) - {i}_{R} ( k ) )}^{2}}}{var ( {I}_{R} )}$$

where i is the intensity value of an element of the corresponding intensity image I.

If e is less than or equal to the minimum acceptable error then stop iteration. Else change parameter values in the set Θ, update transformations and start another iteration.

In this case the output is four registered images and the scaled surface normal matrix S from which surface gradient maps and an albedo image can be derived. The gradient maps may be integrated into a height map with a method such as that disclosed by Frankot in 1988. An example height map of the embossed wallpaper is provided in FIG. 3.

3. Implementation of Photometric Stereo with Unregistered Images (e) Employing User Input for Registration

Procedure is analogous to the implementation of photometric stereo with unregistered images using registration marks (detailed in Embodiment 3a) except it takes user input to effect the registration of the images.

In this embodiment of the current invention the illumination source and sensor may be contained within a flatbed scanner (see FIG. 2).

Acquire input data by scanning a texture sample e.g. embossed wallpaper, which may be attached to a backing plate, under three different orientations.

Result is three intensity images which may be colour or greyscale Iᵢ where i=1 to 3. (See FIG. 4a-c).

Display each of the images to the user and request input e.g. via mouse click on a common feature of the image or positioning of crosswire to provide a co-ordinate (see FIG. 10).

Designate one image to be the reference image e.g. I_{R}=I₁ and the others as floating images e.g. I_{Fi}=Iᵢ₊₁ where i=1 to 2, which are to be geometrically aligned with the reference image. Sample the intensities of the background region (i.e. not material or backing plate) in the reference image and assign the average intensity as the background colour.

Determine the requisite transforms Tᵢ where i=1 to 2.

For example, the simplest case whereby each transform Tᵢ involves a translation and a rotation is given by:

$$Δ {x}_{i} = {x}_{R , 1} - {x}_{{F}_{i} , 1}$$

$$Δ {y}_{i} = {y}_{R , 1} - {y}_{{F}_{i} , 1}$$

$${ϑ}_{i} = {cos}^{- 1} ( {[ {x}_{R , 2} - {x}_{R , 1} , {y}_{R , 2} - {y}_{R , 1} ]}^{T} \cdot {[ {x}_{{F}_{i} , 2} - {x}_{{F}_{i} , 1} , {y}_{{F}_{i ,} 2} - {y}_{{F}_{i} , 1} ]}^{T} )$$

$${T}_{i} = [ \begin{matrix}cos {θ}_{i} & - sin {θ}_{i} & Δ {x}_{i} \\ sin {θ}_{i} & cos {θ}_{i} & Δ {y}_{i} \\ 0 & 0 & 1\end{matrix} ]$$

It is noted that more complex transforms may be required for greater accuracy e.g. affine or projective, in which case the matrix Tᵢ will be defined as a general three by three matrix. In this case there are up to nine parameters to determine for each transformation (rather than three for rotation and translation).

$${T}_{i} = [ \begin{matrix}{t}_{11} & {t}_{12} & {t}_{13} \\ {t}_{21} & {t}_{22} & {t}_{23} \\ {t}_{31} & {t}_{32} & {t}_{33}\end{matrix} ]$$

Transform the floating images. This involves multiplication of each image grid coordinate by the corresponding transform Tᵢ where i=1 to 2:

$$[ \begin{matrix}{x}^{′} \\ {y}^{′} \\ 1\end{matrix} ] = {T}_{i} [ \begin{matrix}x \\ y \\ 1\end{matrix} ]$$

where [x y 1]^{T} is the floating image grid co-ordinate, [x′ y′ 1]^{T} is the transformed image grid co-ordinate, x=0 to (image width-1), y=0 to (image height-1). This operation is likely to produce non-discrete values and in practice will necessitate the use of interpolation to produce discrete co-ordinates. This actually entails an inverse transformation of the known co-ordinates for the grid of the transformed image into non-discrete values corresponding to the floating image grid. Assign the background colour to each co-ordinate in the transformed image for which there is no correspondence. The intensity for each remaining co-ordinate in the transformed image is calculated from the known intensities of the grid co-ordinates surrounding the non-discrete coordinate in the floating image. The transformed floating images I_{Fi(T)} where i=1 to 2, are thus generated.

Use the registered images I_{R}, I_{F1(T)} and I_{F2(T)} to implement the three-image photometric stereo technique.

An intensity matrix I is formed. Each column of I corresponds to one of the three registered images. This operation entails the conversion of each image matrix (2D) to a vector (1D). The matrix I is therefore b by three in size where b=(image width*image height).

$$I = [ \begin{matrix}[ \begin{matrix}⋮ \\ {I}_{R} \\ ⋮\end{matrix} ] & [ \begin{matrix}⋮ \\ {I}_{{F}_{1} ( T )} \\ ⋮\end{matrix} ] & [ \begin{matrix}⋮ \\ {I}_{{F}_{2} ( T )} \\ ⋮\end{matrix} ]\end{matrix} ]$$

An illumination matrix L is formed. The illumination tilt angles τᵢ corresponding to the transformed floating images are deduced from the angles of rotation for the transformations θᵢ. The illumination tilt angle for the reference image is 0°. The illumination slant angle σ is assumed to be constant. It can be measured by implementing a scanner calibration step. In this embodiment we assign a value of 45°. The only consequence is that this introduces a scaling factor into the output data of the photometric stereo algorithm.

$$L = [ \begin{matrix}cos {0}^{∘} sin {45}^{∘} & cos {τ}_{1} sin {45}^{∘} & cos {τ}_{2} sin {45}^{∘} \\ sin {0}^{∘} sin {45}^{∘} & sin {τ}_{1} sin {45}^{∘} & sin {τ}_{2} sin {45}^{∘} \\ cos {45}^{∘} & cos {45}^{∘} & cos {45}^{∘}\end{matrix} ]$$

Assuming Lambertian reflectance, the following can be written: I=SL where S is the scaled surface normal matrix. S is determined by inverting the illumination matrix such that S=IL⁻¹.

In this case the output is three registered images and the scaled surface normal matrix S from which surface gradient maps and an albedo image can be derived. The gradient maps may be integrated into a height map with a method such as that disclosed by Frankot in 1988. An example height map of the embossed wallpaper is provided in FIG. 3.

3. Implementation of Photometric Stereo with Unregistered Images (f) Employing User Input and Optimisation for Registration

The procedure for this embodiment is equivalent to the amalgamation of two previous embodiments (1 and 3e) and uses four input images.

In this embodiment of the current invention the illumination source and sensor may be contained within a flatbed scanner (see FIG. 2).

Acquire input data by scanning a texture sample e.g. embossed wallpaper, which may be attached to a backing plate, under four different orientations.

Result is four intensity images which may be colour or greyscale Iᵢ where i=1 to 4 (see FIG. 4a-d).

Display each of the images to the user and request input e.g. via mouse click on a common feature of the image or positioning of crosswire to provide a co-ordinate (see FIG. 10).

Designate one image to be the reference image e.g. I_{R}=I₁ and the others as floating images e.g. I_{Fi}=Iᵢ₊₁ where i=1 to 3, which are to be geometrically aligned with the reference image. Sample the intensities of the background region (i.e. not material or backing plate) in the reference image and assign the average intensity as the background colour.

Determine the requisite transforms Tᵢ where i=1 to 3.

For example, the simplest case whereby each transform Tᵢ involves a translation and a rotation is given by:

$$Δ {x}_{i} = {x}_{R , 1} - {x}_{{F}_{i} , 1}$$

$$Δ {y}_{i} = {y}_{R , 1} - {y}_{{F}_{i} , 1}$$

$${ϑ}_{i} = {cos}^{- 1} ( {[ {x}_{R , 2} - {x}_{R , 1} , {y}_{R , 2} - {y}_{R , 1} ]}^{T} \cdot {[ {x}_{{F}_{i} , 2} - {x}_{{F}_{i} , 1} , {x}_{{F}_{1} , 2} - {y}_{{F}_{i} , 1} ]}^{T} )$$

$${T}_{i} = [ \begin{matrix}cos {θ}_{i} & - sin {θ}_{i} & Δ {x}_{i} \\ sin {θ}_{i} & cos {θ}_{i} & Δ {y}_{i} \\ 0 & 0 & 1\end{matrix} ]$$

It is noted that more complex transforms may be required for greater accuracy e.g. affine, projective. In general the matrix Tᵢ is defined as a general three by three matrix and there are potentially nine parameters to determine for each transformation (rather than three for rotation translation).

$${T}_{i} = [ \begin{matrix}{t}_{11} & {t}_{12} & {t}_{13} \\ {t}_{21} & {t}_{22} & {t}_{23} \\ {t}_{31} & {t}_{32} & {t}_{33}\end{matrix} ]$$

Use the data generated to populate the parameter set Θ.

Θ=[(θ₁, Δx₁, Δy₁), (θ₂, Δx₂, Δy₂) (θ₃, Δx₃, Δy₃)]

Refine the transformations by performing an optimisation as follows:

Begin loop.

Transform the floating images. This involves multiplication of each image grid co-ordinate by the corresponding transform Tᵢ:

$$[ \begin{matrix}{x}^{′} \\ {y}^{′} \\ 1\end{matrix} ] = {T}_{i} [ \begin{matrix}x \\ y \\ 1\end{matrix} ]$$

where [x y 1]^{T} is the floating image grid co-ordinate, [x′ y′ 1]^{T} is the transformed image grid co-ordinate, x=0 to (image width-1), y=0 to (image height-1). This operation is likely to produce non-discrete values and in practice will necessitate the use of interpolation to produce discrete co-ordinates. This actually entails an inverse transformation of the known co-ordinates for the grid of the transformed image into non-discrete values corresponding to the floating image grid. Assign the background colour to each co-ordinate in the transformed image for which there is no correspondence. The intensity for each remaining coordinate in the transformed image is calculated from the known intensities of the grid co-ordinates surrounding the non-discrete coordinate in the floating image. The transformed floating images I_{Fi(T)} where i=1 to 3, are thus generated.

A number of images are then used to implement photometric stereo; these are chosen from the reference or transformed floating images. In this embodiment we opt for the three-image photometric stereo algorithm and use transformed images I_{Fi(T)} where i=1, 2, 3 as input data.

An intensity matrix I is formed. Each column of I corresponds to one of the images I_{Fi(T)}. This operation entails the conversion of each image matrix (2D) to a vector (1D). The matrix I is therefore b by three in size where b=(image width*image height).

$$I = [ \begin{matrix}[ \begin{matrix}⋮ \\ {I}_{{F}_{1} ( T )} \\ ⋮\end{matrix} ] & [ \begin{matrix}⋮ \\ {I}_{{F}_{2} ( T )} \\ ⋮\end{matrix} ] & [ \begin{matrix}⋮ \\ {I}_{{F}_{3} ( T )} \\ ⋮\end{matrix} ]\end{matrix} ]$$

An illumination matrix L is formed. This requires the illumination vector corresponding to each image to be defined. The illumination tilt angles τᵢ are deduced from the angles of rotation for the three transformations θᵢ. The illumination slant angle σ is assumed to be constant. It could be measured by implementing a scanner calibration step but in this embodiment we assign a value of 45°. The only consequence is that this introduces a scaling factor into the output data of the photometric stereo algorithm.

$$L = [ \begin{matrix}cos {τ}_{1} sin 45 ° & cos {τ}_{2} sin 45 ° & cos {τ}_{3} sin 45 ° \\ sin {τ}_{1} sin 45 ° & sin {τ}_{2} sin 45 ° & sin {τ}_{3} sin 45 ° \\ cos 45 ° & cos 45 ° & cos 45 °\end{matrix} ]$$

Assuming Lambertian reflectance, the following can be written: I=SL where S is the scaled surface normal matrix. S is determined by inverting the illumination matrix such that S=IL⁻¹.

Phong reflectance could also be used but would necessitate an increase in the number of parameters to be optimised. In this case the parameter set would be increased to include a term R. For diffuse reflection R would be null. For specular reflection R would consist of two parameters: the Phong exponent and the proportion of specular to diffuse reflection.

Θ=[(θ₁, Δx₁, Δy₁), (θ₂, Δx₂, Δy₂), (θ₃, Δx₃, Δy₃), R]

An estimate of the reference image is generated using the scaled surface normals. In this case we assume that the illumination tilt angle r=0°. The slant angle is taken as 45° due to the previous assumption.

$${I}_{R ( EST )} = {SI}_{R}$$

$$\begin{matrix}{I}_{R} = {( \begin{matrix}cos 0 °sin45° & sin 0 °sin45° & cos 45 °\end{matrix} )}^{T} \\ = {( \begin{matrix}0.707 & 0.0 & 0.707\end{matrix} )}^{T}\end{matrix}$$

The difference between the estimated reference image and the actual reference image is determined in terms of a suitable measure such as the mean square error e:

$$e = \frac{\frac{1}{b} \sqrt{{\sum }_{k = 1}^{b} {( {i}_{R ( EST )} ( k ) - {i}_{R} ( k ) )}^{2}}}{var ( {I}_{R} )}$$

where i is the intensity value of an element of the corresponding intensity image I.

If e is less than or equal to the minimum acceptable error then stop iteration. Else change parameter values in the set Θ, update the transformations and start another iteration.

In this case the output is four registered images and the scaled surface normal matrix S from which surface gradient maps and an albedo image can be derived. The gradient maps may be integrated into a height map. An example height map of the embossed wallpaper is provided in FIG. 3.

3. Implementation of Photometric Stereo with Unregistered Images (g) Using Mechanical Device Input for Registration

Procedure is analogous to the implementation of photometric stereo with unregistered images using registration marks (detailed in Embodiment 3a) except it uses input from a mechanical device to effect the registration of the images.

In this embodiment of the current invention the illumination source and sensor may be contained within a flatbed scanner (see FIG. 2).

Acquire input data by scanning a texture sample e.g. embossed wallpaper, which may be attached to a backing plate on a mechanical device e.g. calibrated turntable, under three different orientations.

Result is three intensity images which may be colour or greyscale Iᵢ where i=1 to 3 (see FIG. 4a-c).

Designate one image to be the reference image e.g. I_{R}=I₁ and the others as floating images e.g. I_{Fi}=Iᵢ₊₁ where i=1 to 2, which are to be geometrically aligned with the reference image. Sample the intensities of the background region (i.e. not material or backing plate) in the reference image and assign the average intensity as the background colour.

Request input of the data read from the mechanical device.

Determine the requisite transforms Tᵢ where i=1 to 2.

For example, the simplest case whereby each transform Tᵢ involves a translation and a rotation is given by:

$$Δ {x}_{i} = {x}_{R , 1} - {x}_{{F}_{i} , 1}$$

$$Δ {y}_{i} = {y}_{R , 1} - {y}_{{F}_{i} , 1}$$

$${ϑ}_{i} = {cos}^{- 1} ( {[ {x}_{R , 2} - {x}_{R , 1} , {y}_{R , 2} - {y}_{R , 1} ]}^{T} \cdot {[ {x}_{{F}_{i} , 2} - {x}_{{F}_{i} , 1} , {y}_{{F}_{i} , 2} - {y}_{{F}_{i} , 1} ]}^{T} )$$

$${T}_{i} = [ \begin{matrix}cos {θ}_{i} & - sin {θ}_{i} & Δ {x}_{i} \\ sin {θ}_{i} & cos {θ}_{i} & Δ {y}_{i} \\ 0 & 0 & 1\end{matrix} ]$$

It is noted that more complex transforms may be required for greater accuracy e.g. affine, projective. In general the matrix Tᵢ is defined as a general three by three matrix and there are potentially nine parameters to determine for each transformation (rather than three for rotation translation).

$${T}_{i} = [ \begin{matrix}{t}_{11} & {t}_{12} & {t}_{13} \\ {t}_{21} & {t}_{22} & {t}_{23} \\ {t}_{31} & {t}_{32} & {t}_{33}\end{matrix} ]$$

Transform the floating images. This involves multiplication of each image grid co-ordinate by the corresponding transform Tᵢ where i=1 to 2:

$$[ \begin{matrix}{x}^{′} \\ {y}^{′} \\ 1\end{matrix} ] = {T}_{i} [ \begin{matrix}x \\ y \\ 1\end{matrix} ]$$

where [x y 1]^{T} is the floating image grid co-ordinate, [x′ y′ 1]^{T} is the transformed image grid co-ordinate, x=0 to (image width-1), y=0 to (image height-1). This operation is likely to produce non-discrete values and in practice will necessitate the use of interpolation to produce discrete co-ordinates. This actually entails an inverse transformation of the known co-ordinates for the grid of the transformed image into non-discrete values corresponding to the floating image grid. Assign the background colour to each co-ordinate in the transformed image for which there is no correspondence. The intensity for each remaining co-ordinate in the transformed image is calculated from the known intensities of the grid co-ordinates surrounding the non-discrete coordinate in the floating image. The transformed floating images I_{Fi(T)} where i=1 to 2, are thus generated.

Use the registered images I_{R}, I_{F1(T)} and I_{F2(T)} to implement the three-image photometric stereo technique.

An intensity matrix I is formed. Each column of I corresponds to one of the three registered images. This operation entails the conversion of each image matrix (2D) to a vector (1D). The matrix I is therefore b by three in size where b=(image width*image height).

$$I = [ \begin{matrix}[ \begin{matrix}⋮ \\ {I}_{R} \\ ⋮\end{matrix} ] & [ \begin{matrix}⋮ \\ {I}_{{F}_{1} ( T )} \\ ⋮\end{matrix} ] & [ \begin{matrix}⋮ \\ {I}_{{F}_{2} ( T )} \\ ⋮\end{matrix} ]\end{matrix} ]$$

An illumination matrix L is formed. The illumination tilt angles τᵢ corresponding to the transformed floating images are deduced from the angles of rotation for the transformations θᵢ. The illumination tilt angle for the reference image is 0°. The illumination slant angle σ is assumed to be constant. It could be measured by implementing a scanner calibration step but in this embodiment we assign a value of 45°. The only consequence is that this introduces a scaling factor into the output data of the photometric stereo algorithm.

$$L = [ \begin{matrix}cos 0 °sin 45 ° & cos {τ}_{1} sin 45 ° & cos {τ}_{2} sin 4 \text{-} 5 ° \\ sin 0 °sin 45 ° & sin {τ}_{1} sin 45 ° & sin {τ}_{2} sin 4 \text{-} 5 ° \\ cos 45 ° & cos 45 ° & cos 45 °\end{matrix} ]$$

Assuming Lambertian reflectance, the following can be written: I=SL where S is the scaled surface normal matrix. S is determined by inverting the illumination matrix such that S=IL⁻¹.

In this case the output is three registered images and the scaled surface normal matrix S from which surface gradient maps and an albedo image can be derived. The gradient maps may be integrated into a height map with a method such as that disclosed by Frankot in 1988. An example height map of the embossed wallpaper is provided in FIG. 3

3. Implementation of Photometric Stereo with Unregistered Images (h) Using Mechanical Device Input and Optimisation for Registration

The procedure for this embodiment is equivalent to the amalgamation of two previous embodiments (1 and 3g) and uses four input images.

In this embodiment of the current invention the illumination source and sensor may be contained within a flatbed scanner (see FIG. 2).

Acquire input data by scanning a texture sample e.g. embossed wallpaper, which may be attached to a backing plate on a mechanical device e.g. calibrated turntable, under four different orientations.

Result is four intensity images which may be colour or greyscale Iᵢ where i=1 to 4 (see FIG. 4a-d).

Designate one image to be the reference image e.g. I_{R}=I₁ and the others as floating images e.g. I_{Fi}=Iᵢ₊₁ where i=1 to 3, which are to be geometrically aligned with the reference image. Sample the intensities of the background region (i.e. not material or backing plate) in the reference image and assign the average intensity as the background colour.

Request input of the data read from the mechanical device.

Determine the requisite transforms Tᵢ where i=1 to 3.

For example, the simplest case whereby each transform Tᵢ involves a translation and a rotation is given by:

$$Δ {x}_{i} = {x}_{R , 1} - {x}_{{F}_{i} , 1}$$

$$Δ {y}_{i} = {y}_{R , 1} - {y}_{{F}_{i} , 1}$$

$${ϑ}_{i} = {cos}^{- 1} ( {[ {x}_{R , 2} - {x}_{R , 1} , {y}_{R , 2} - {y}_{R , 1} ]}^{T} \cdot {[ {x}_{{F}_{i} , 2} - {x}_{{F}_{i} , 1} , {y}_{{F}_{i} , 2} - {y}_{{F}_{i} , 1} ]}^{T} )$$

$${T}_{i} = [ \begin{matrix}cos {θ}_{i} & - sin {θ}_{i} & Δ {x}_{i} \\ sin {θ}_{i} & cos {θ}_{i} & Δ {y}_{i} \\ 0 & 0 & 1\end{matrix} ]$$

It is noted that more complex transforms may be required for greater accuracy e.g. affine, projective. In general the matrix Tᵢ is defined as a general three by three matrix and there are potentially nine parameters to determine for each transformation (rather than three for rotation translation).

$${T}_{i} = [ \begin{matrix}{t}_{11} & {t}_{12} & {t}_{13} \\ {t}_{21} & {t}_{22} & {t}_{23} \\ {t}_{31} & {t}_{32} & {t}_{33}\end{matrix} ]$$

Use the data generated to populate the parameter set Θ.

Θ=[(θ₁, Δx₁, Δy₁), (θ₂, Δx₂, Δy₂), (θ₃, Δx₃, Δy₃)]

Refine the transformations by performing an optimisation as follows:

Begin loop.

Transform the floating images. This involves multiplication of each image grid co-ordinate by the corresponding transform Tᵢ:

$$[ \begin{matrix}{x}^{′} \\ {y}^{′} \\ 1\end{matrix} ] = {T}_{i} [ \begin{matrix}x \\ y \\ 1\end{matrix} ]$$

where [x y 1]^{T} is the floating image grid co-ordinate, [x′ y′ 1]^{T} is the transformed image grid co-ordinate, x=0 to (image width-1), y=0 to (image height-1). This operation is likely to produce non-discrete values and in practice will necessitate the use of interpolation to produce discrete co-ordinates. This actually entails an inverse transformation of the known co-ordinates for the grid of the transformed image into non-discrete values corresponding to the floating image grid. Assign the background colour to each co-ordinate in the transformed image for which there is no correspondence. The intensity for each remaining co-ordinate in the transformed image is calculated from the known intensities of the grid co-ordinates surrounding the non-discrete coordinate in the floating image. The transformed floating images I_{Fi(T)} where i=1 to 3, are thus generated.

A number of images are then used to implement photometric stereo; these are chosen from the reference or transformed floating images. In this embodiment we opt for the three-image photometric stereo algorithm and use transformed images I_{Fi(T)} where i=1, 2, 3 as input data.

An intensity matrix I is formed. Each column of I corresponds to one of the images I_{Fi(T)}. This operation entails the conversion of each image matrix (2D) to a vector (1D). The matrix I is therefore b by three in size where b==(image width*image height).

$$I = [ \begin{matrix}[ \begin{matrix}⋮ \\ {I}_{{F}_{1} ( T )} \\ ⋮\end{matrix} ] & [ \begin{matrix}⋮ \\ {I}_{{F}_{2} ( T )} \\ ⋮\end{matrix} ] & [ \begin{matrix}⋮ \\ {I}_{{F}_{3} ( T )} \\ ⋮\end{matrix} ]\end{matrix} ]$$

An illumination matrix L is formed. This requires the illumination vector corresponding to each image to be defined. The illumination tilt angles τᵢ are deduced from the angles of rotation for the three transformations θᵢ. The illumination slant angle σ is assumed to be constant. It could be measured by implementing a scanner calibration step but in this embodiment we assign a value of 45°. The only consequence is that this introduces a scaling factor into the output data of the photometric stereo algorithm.

$$L = [ \begin{matrix}cos {τ}_{1} sin 45 ° & cos {τ}_{2} sin 45 ° & cos {τ}_{3} sin 45 ° \\ sin {τ}_{1} sin 45 ° & sin {τ}_{2} sin 45 ° & sin {τ}_{3} sin 45 ° \\ cos 45 ° & cos 45 ° & cos 45 °\end{matrix} ]$$

Assuming Lambertian reflectance, the following can be written: I=SL where S is the scaled surface normal matrix. S is determined by inverting the illumination matrix such that S=IL⁻¹.

Phong reflectance could also be used but would necessitate an increase in the number of parameters to be optimised. In this case the parameter set would be increased to include a term R. For diffuse reflection R would be null. For specular reflection R would consist of two parameters: the Phong exponent and the proportion of specular to diffuse reflection.

Θ=[(θ₁, Δx₁, Δy₁), (θ₂, Δx₂, Δy₂), (θ₃, Δx₃, Δy₃), R]

An estimate of the reference image is now generated using the scaled surface normals. In this case we assume that the illumination tilt angle τ=0°. The slant angle is taken as 45° due to the previous assumption.

$${I}_{R ( EST )} = {SI}_{R}$$

$$\begin{matrix}{I}_{R} = {( \begin{matrix}cos 0 °sin45° & sin 0 °sin45° & cos 45 °\end{matrix} )}^{T} \\ = {( \begin{matrix}0.707 & 0.0 & 0.707\end{matrix} )}^{T}\end{matrix}$$

The difference between the estimated reference image and the actual reference image is determined in terms of a suitable measure such as the mean square error e:

$$e = \frac{\frac{1}{b} \sqrt{{\sum }_{k = 1}^{b} {( {i}_{R ( EST )} ( k ) - {i}_{R} ( k ) )}^{2}}}{var ( {I}_{R} )}$$

where i is the intensity value of an element of the corresponding intensity image I.

If e is less than or equal to the minimum acceptable error then stop iteration. Else change parameter values in the set Θ, update the transformations and start another iteration.

In this case the output is four registered images and the scaled surface normal matrix S from which surface gradient maps and an albedo image can be derived. The gradient maps may be integrated into a height map. An example height map of the embossed wallpaper is provided in FIG. 3.

FIG. 13 shows a second embodiment of an apparatus in accordance with the present invention. The apparatus 101 comprises a camera 103 and a light 105 which are positioned in a fixed relationship with respect to one another, the light 105 being angled with respect to the sample space 107 upon which a sample 109 is positioned.

This embodiment of the present invention could be realised in a stand-alone instrument suitable for performing photometric stereo. Control of the apparatus and the processing means may be provided by software loaded onto the instrument such that intensity data produced by the camera is processed to generate surface information by application of the photometric stereo techniques described herein.

FIG. 14 is a flow chart for the image acquisition technique. As previously described the present invention can be implemented using a flatbed scanner in which software is loaded in order to operate the scanner and suitable processing means to provide photometric stereo input images and hence generate surface information by application of the photometric stereo techniques described herein.

The flowchart 111 shows that the texture sample is placed on the scanner 113, a reference image is acquired, the sample is then rotated preferably through an angle approximately 90 degrees 117 to allow the acquisition of a floating image 119. The steps that allow acquisition of a floating image have repeated several times such that a total of n images are acquired, the first image being a reference image and the other (n−1) images being floating images.

FIG. 15 is a flow chart describing the basic implementation of an algorithm for image registration and reflectance/surface normal data production. The flow chart 125 describes the analysis of n unregistered texture images 127 acquired in this example using the technique described with reference to FIG. 14. Where point correspondences 129 are not estimated an initial guess for transformations 135 is provided and the floating images are transformed 139. Wherein (n−1) images have been transformed 141, photometric stereo is performed 145 and scaled normal surface estimates 147 are obtained.

The system may then be optimised by 149 re-lighting the scaled surface normals 153 estimating the reference image 155, calculating the intensity error 157 and adjusting the transformations 137 to minimise the error in the estimated transformation. Where substantially simultaneous photometric stereo and image registration are used the optimisation process may be repeated a number of times but the eventual process results 151 are n registered texture images 159, reflectance images 161, or surface normal images 163. Where image registration occurs before photometric stereo calculation is performed, registration marks or similar provided on the texture 131 are used to estimate transformations 133.

FIG. 16 is a flow chart that shows strategies for increased speed of optimisation using the method and apparatus of the present invention. n unregistered texture images 169 are provided and an estimate or guess of the transformation 167 is applied to the n unregistered images as described previously. A sub-sample of the images 171 is taken and n half size texture images are obtained. The method then determines whether the lowest resolution is required 175 if not then the loop from boxes 171 to 175 is repeated until the lowest resolution required is provided.

Thereafter, it is determined whether the images should be sampled at this resolution. If so, then the section co-ordinates in the image are recorded and the corresponding sections of the floating images are transformed. If the sub-sampled image is not sampled, a transform of the whole of the floating images is otherwise undertaken. Next the (n−1) transformed images or sections thereof and the reference image or a section thereof 189 & 191 respectively are processed with the photometric stereo algorithm 193. The scaled surface normal estimates are then obtained 197 and the decision is then made to whether optimisation of the transforms should be continued based on the magnitude of the intensity error. Where optimisation is continued the scaled surface normals are re-lit and a further reference image or section estimate is obtained 199. An error intensity calculation is performed to gauge the difference between the actual reference image and its estimate. The value of the new error allows the transform to be adjusted 187 through application of a minimisation technique such as Nelder-Mead and the new transformations are re-applied to transform the floating images. Where optimisation is not continued it is possible to decide to use a higher resolution in which case higher resolution texture images and the current transformations 179 and 181 respectively are used as input and the process of transforming the floating images is restarted. When the optimisation is not continued at the highest resolution i.e. that corresponding to the original input images, the process is complete. As with the previous embodiment the process results for the output comprise n registered texture images, reflectance images and surface normal images 209, 211 and 213 respectively.

The present invention is particularly useful for obtaining surface information which may be used to construct images of the surface under user-specified orientations, viewpoints, lighting direction, number of light sources, reflection models which provide real, convincing and accurate depictions of textured surfaces which may be applied to texture the surface of virtual 3D objects described by polygon models. A large variety of textured surfaces can be generated using man-made surface samples or naturally-occurring texture samples. Examples of the former include but are not exclusive to embossed wallpaper, laminate flooring including reproduction and replica of wooden flooring, wood products such as MDF, woven textiles, knitted textiles, brick, concrete, carved or sculpted reliefs, plastic moulds or the like. Examples of the latter include but are not exclusive to stone, pebbles, sand, wood, tree bark, leaves, skin or the like.

It is an advantage of the present invention that it can be linked into an existing flatbed scanner or similar device and be used with the minimum of instruction without the need for expert knowledge of photometric stereo. The present invention may be embodied on a computer disc that is loaded into a computer for operating a flatbed scanner or the like. As previously described the user simply rotates the position of the texture sample upon the plate of the flatbed scanner in order to allow the apparatus and method of the present invention to perform photometric stereo and produce surface description data for the texture sample.

The present invention may also be provided as a stand-alone apparatus with software preloaded in it in order to provide the user with separate equipment to allow photometric stereo to be implemented and hence produce surface texture descriptions.

The invention described herein gives the user the ability to produce surface height or gradient maps and surface reflectance using a flatbed scanner.

The invention described herein provides a technical advantage in that the incident illumination is constant across the target surface such that only one light source is required.

The invention may be utilised to capture bump maps for augmented reality applications, such as in architectural design. There are many more potential applications in the fields of computer games and surface inspection, for example.

Improvements and modifications may be incorporated herein without deviating from the scope of the invention.

1. An apparatus for obtaining surface texture information, the apparatus comprising:
an illumination source for illuminating a sample space and an imaging sensor for capturing images of the sample space; wherein the effective position of the illumination source and the image sensor with respect to a sample space is substantially constant and the sample space is configured to allow the orientation of a sample with respect to the illumination source to be altered; and
a processor for processing the captured images to allow surface texture information to be obtained from the sample.

2. The apparatus of claim 1, wherein the illumination source and imaging sensor are mounted for movement across the sample space.

3. The apparatus of claim 2, wherein the illumination source and imaging sensor are mounted to scan the sample space.

4. The apparatus of claim 1, wherein the sample space comprises a transparent sample support plate positioned in the line of sight of the illumination source and imaging sensor.

5. The apparatus of claim 1, wherein the illumination source, image sensor, and sample space comprise a flatbed scanner.

6. The apparatus of claim 1, wherein the imaging sensor and illumination source are fixed in position with respect to the sample space.

7. The apparatus of claim 6, wherein the imaging sensor and illumination source are positioned such that a whole image is captured at once.

8. The apparatus of claim 1, wherein the sample space is rotatably mounted.

9. The apparatus of claim 8, wherein a degree of rotation of the sample space is measurable.

10. The apparatus of claim 1, wherein the processor is adapted to:
receive n unregistered images;
define a reference image;
register unregistered floating images by obtaining a transformation for transforming at least some of (n−1) floating images to spatially align them with the reference image; and
performing a photometric stereo technique to produce sample texture information.

11. The apparatus of claim 10, wherein registering the images occurs prior to the application of the photometric stereo technique.

12. The apparatus of claim 10, wherein registering the images occurs substantially simultaneously with the application of the photometric stereo technique.

13. The apparatus of claim 10, wherein obtaining a transformation to be applied to a floating image comprises estimating the transformation to be applied to the floating image.

14. The apparatus of claim 10, wherein obtaining a transformation to be applied to a floating image comprises optimising the transformation.

15. The apparatus of claim 14, wherein optimising the transformation comprises calculating an error and adjusting the transformation so as to minimise the error.

16. The apparatus of claim 14, wherein optimising the transformation comprises generating an estimated reference image.

17. The apparatus of claim 14, wherein generating an estimated reference image uses scaled surface normals.

18. The apparatus of claim 10, wherein at least one of the n unregistered images comprises an image of the entire sample.

19. The apparatus of claim 10, wherein at least one of the n unregistered images comprise a section of the sample.

20. The apparatus of claim 19, wherein the section of the surface comprises a frame section.

21. The apparatus of claim 20, wherein the frame section is w pixels in width.

22. The apparatus of claim 10, wherein registering the image further comprises:
defining common reference points on each of the images; and
providing an estimated transformation for the image by calculating the transformation applicable to the reference points.

23. The apparatus of claim 22, wherein the common reference points comprise a plurality of registration marks.

24. The apparatus of claim 22, wherein the common reference points comprise edges in the sample.

25. The apparatus of claim 22, wherein the common reference points are defined by the background sample space adjacent to the sample.

26. The apparatus of claim 22, wherein the common reference points comprise areas of the sample which may be of distinctive hue or determined by user input.

27. The apparatus of claim 10, wherein the step of registering the images comprises determining the angle of rotation to spatially align the images.

28. A method of obtaining surface texture information, the method comprising the steps of:
receiving n unregistered images;
defining a reference image;
registering unregistered floating images by obtaining a transformation for transforming at least some of (n−1) floating images to spatially align them with the reference image; and
performing a photometric stereo technique to produce sample texture information.

29. The method of claim 28, wherein the step of registering the images occurs prior to the application of the photometric stereo technique.

30. The method of claim 28, wherein the step at registering the images occurs substantially simultaneously with the application of the photometric stereo technique.

31. The method of claim 28, wherein the step of obtaining a transformation to be applied to a floating image comprises estimating the transformation to be applied to the floating image.

32. The method of claim 28, wherein the step of obtaining a transformation to be applied to a floating image comprises optimising the transformation.

33. The method claim 32, wherein the step of optimising the transformation comprises:
calculating an error; and
adjusting the transformation so as to minimise the error.

34. The method of claim 32, wherein the step of optimising the transformation comprises generating an estimated reference image.

35. The method of claim 32, wherein the step of generating an estimated reference image uses scaled surface normals.

36. The method of claim 28, wherein at least one of the n unregistered images comprise an image of the entire sample.

37. The method of claim 28, wherein at least one of the n unregistered images comprise a section of the sample.

38. The method of claim 37, wherein the section of the surface comprises a frame section.

39. The method of claim 38, wherein the frame section is w pixels in width.

40. The method of claim 28, wherein the step of registering the image further comprises:
defining common reference points on each of the images; and
providing an estimated transformation for the image by calculating the transformation applicable to the reference points.

41. The method of claim 40, wherein the common reference points comprise a plurality of registration marks.

42. The method of claim 40, wherein the common reference points comprise edges in the sample.

43. The method of claim 40, wherein the common reference points are defined by the background sample space adjacent to the sample.

44. The method of claim 40, wherein the common reference points are areas of the sample which may be of distinctive hue or determined by user input.

45. The method of claim 28, wherein the step of registering the images comprises determining the angle of rotation to spatially align the images.

46. A computer program comprising process instructions for causing computing means to perform the method of claim 28.

47. The computer program of claim 46, wherein the computer program is stored on a record medium.

48. The computer program of claim 46, wherein the computer program is stored in computer memory.

49. A scanner adapted to run computer software to cause the scanner to perform the method of claim 28.

50. The scanner of claim 49, wherein the scanner is a flatbed scanner.
